(19) United States
(12) Patent Application Publication
(10) Pub. No.: US 2023/0120585 A1
(43) Pub. Date: Apr. 20, 2023

(54) CYLINDRICAL SECONDARY BATTERY

(71) Applicant: Samsung SDI Co., Ltd., Yongin-si (KR)

(72) Inventor: Deok Ho JEON, Yongin-si (KR)

(21) Appl. No.: 18/046,407

(22) Filed: Oct. 13, 2022

(30) Foreign Application Priority Data
Oct. 19, 2021 (KR) 10-2021-0139522

(51) Int. Cl. H01M 50/107; H01M 50/183; H01M 50/152; H01M 10/0585; H01M 50/46

(52) U.S. Cl. CPC H01M 50/107; H01M 10/0585; H01M 50/46; H01M 50/152; H01M 50/183

(57) ABSTRACT

A secondary battery includes: a cylindrical can; an electrode assembly in the cylindrical can; and a cap assembly sealing the electrode assembly by closing the cylindrical can. The electrode assembly includes: a positive electrode plate having a winding leading edge, an inner surface, and an outer surface; a first separator covering the inner surface of the positive electrode plate; a second separator covering the outer surface of the positive electrode plate; and a negative electrode plate on the first separator. The first and second separators have a positive electrode protection region provided in a region corresponding to the winding leading edge of the positive electrode plate.

### CROSS-REFERENCE TO RELATED APPLICATION

This application claims priority to and the benefit of Korean Patent Application No. 10-2021-0139522, filed on Oct. 19, 2021, in the Korean Intellectual Property Office, the entire contents of which are herein incorporated by reference.

### BACKGROUND

### 1. Field

Aspects of embodiments of the present disclosure relate to a cylindrical secondary battery.

### 2. Description of the Related Art

Generally, a cylindrical secondary battery includes a cylindrical electrode assembly, a cylindrical can accommodating the electrode assembly and an electrolyte, and a cap assembly coupled to a top opening of the can to seal the can and to allow the current generated by (e.g., stored by) the electrode assembly to flow to an external device.

In some examples, a method for winding the electrode assembly may include first winding the ends (e.g., leading edges) of two separators by bonding them to a core member, placing a positive electrode plate (or a negative electrode plate) between the two separators, and rotating the core member so that the positive electrode plate, the negative electrode plate, and the separators are wound in a substantially cylindrical shape. In this example, the end (e.g., the leading edge) of the positive electrode plate is inserted later than the end (e.g., leading edge) of the negative electrode plate, and thus, the end of the positive electrode plate is generally positioned between (e.g., is covered by) the two separators.

However, when the end of the positive electrode plate is sharply cut and has a burr, the burr may pass through the separators, resulting the positive electrode plate to be directly shorted to the negative electrode plate, causing a defect. In other words, the end of the positive electrode plate in the approximately winding center region (e.g., the region where winding starts) of the electrode assembly may damage the separators, which may cause a defect that reduces the safety of the battery.

The above information disclosed in this Background section is for enhancement of understanding of the background of the present disclosure and, therefore, it may contain information that does not constitute prior art.

### SUMMARY

The present disclosure provides a cylindrical secondary battery that prevents a direct short circuit between a positive electrode plate and a negative electrode plate in a winding center region (e.g., a region where winding starts) of an electrode assembly.

According to the present disclosure, a cylindrical secondary battery is provided in which an end of a positive electrode plate is not directly shorted to a negative electrode plate even if the end of the positive electrode plate has a burr or the end of the positive electrode plate is deformed in a winding center region of an electrode assembly.

A secondary battery, according to an embodiment of the present disclosure, includes: a cylindrical can; an electrode assembly accommodated in the cylindrical can; and a cap assembly sealing the electrode assembly by closing the cylindrical can. The electrode assembly includes: a positive electrode plate having a winding leading edge, an inner surface, and an outer surface; a first separator covering the inner surface of the positive electrode plate; a second separator covering the outer surface of the positive electrode plate; and a negative electrode plate on the first separator. The first and second separators have a positive electrode protection region at a region corresponding to the winding leading edge of the positive electrode plate.

The positive electrode protection region may include a region of at least three layers of separators.

The positive electrode protection region may include a one-layer separator region provided by the first separator and a two-layer separator region provided by the second separator.

The positive electrode protection region may be on the outer surface of the positive electrode plate.

The positive electrode protection region may be on the inner surface of the positive electrode plate.

Each of the first and second separators may have a winding leading edge, and the winding leading edges of the first and second separators may be on the outer surface of the positive electrode plate.

Each of the first and second separators may include a winding leading edge, and the winding leading edges of the first and second separators may be on the inner surface of the positive electrode plate.

The winding leading edge of the positive electrode plate may be on the negative electrode plate.

The positive electrode protection region may include a region of at least two layers of separators.

The positive electrode protection region may be on the outer surface of the positive electrode plate and the inner surface of the positive electrode plate.

The positive electrode protection region may include a two-layer separator region provided by the first separator and a two-layer separator region provided by the second separator.

Each of the first and second separators may have a winding leading edge. The winding leading edge of the first separator may be on the inner surface of the positive electrode plate, and the winding leading edge of the second separator may be on the outer surface of the positive electrode plate.

The positive electrode protection region may include a first insulating layer attached to the first separator and a second insulating layer attached to the second separator.

### BRIEF DESCRIPTION OF DRAWINGS

FIGS. 1A, 1B, and 1C are a perspective view, a cross-sectional view, and a exploded perspective view, respectively, showing a cylindrical secondary battery according to an embodiment of the present disclosure.

FIGS. 2A, 2B, 2C, and 2D are views showing a winding method, a winding plane, a winding center (half), and a winding center (part), respectively, of an electrode assembly in a cylindrical secondary battery according to an embodiment of the present disclosure.

FIGS. 3A, 3B, 3C, and 3D are views showing a winding method, a winding plane, a winding center (half), and a winding center (part), respectively, of an electrode assembly in a cylindrical secondary battery according to an embodiment of the present disclosure.

FIGS. 4A, 4B, 4C, and 4D are views showing a winding method, a winding plane, a winding center (half), and a winding center (part), respectively, of an electrode assembly in a cylindrical secondary battery according to an embodiment of the present disclosure.

FIGS. 5A, 5B, 5C, and 5D are views showing a winding method, a winding plane, a winding center (half), and a winding center (part), respectively, of an electrode assembly in a cylindrical secondary battery according to an embodiment of the present disclosure.

### DETAILED DESCRIPTION

Examples of the present disclosure are provided to more fully explain the present disclosure to those skilled in the art, and the following examples may be modified in various other forms. In other words, the present disclosure may be embodied in many different forms and should not be construed as being limited to the embodiments set forth herein. Rather, these embodiments are provided so that this disclosure will be thorough and complete and will convey the aspects and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

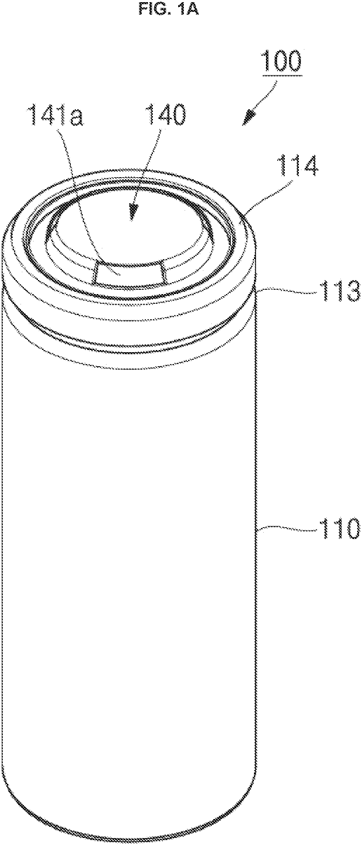

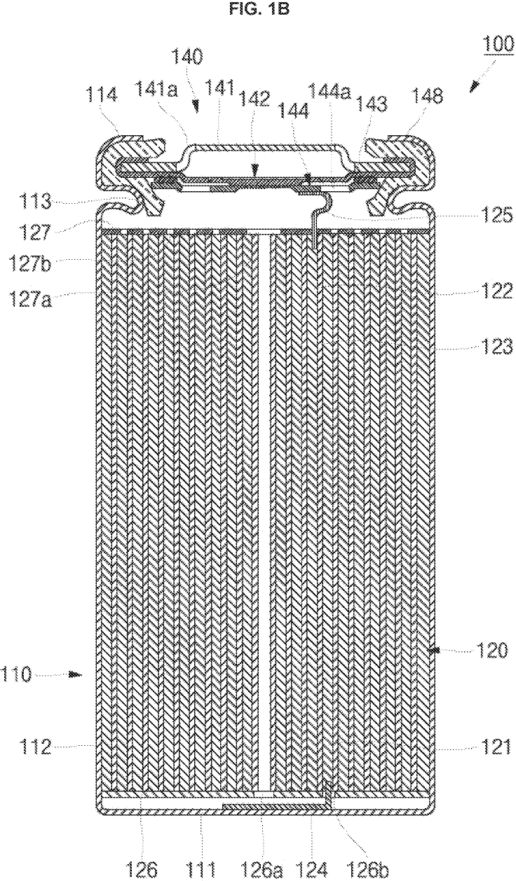

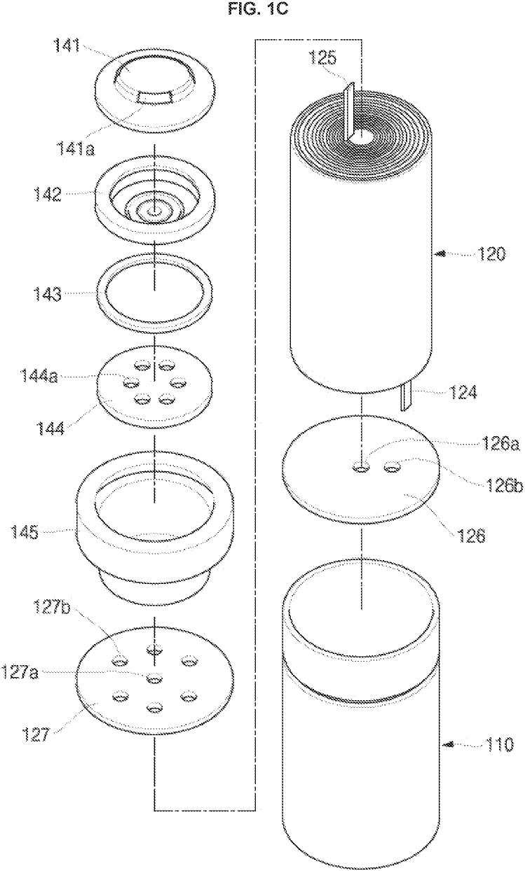

FIGS. 1A, 1B, and 1C are a perspective view, a cross-sectional view, and a exploded perspective view, respectively, of a cylindrical secondary battery according to an embodiment of the present disclosure.

As shown in FIGS. 1A, 1B, and 1C, the secondary battery 100 according to an embodiment of the present disclosure may include a cylindrical can 110, a cylindrical electrode assembly 120, and a cap assembly 140.

The cylindrical can 110 may have a circular bottom portion 111 and a cylindrical side portion 112 extending upwardly (e.g., extending to have a predetermined length upwardly) from the bottom portion 111. During the manufacturing process of the secondary battery, an upper portion of the cylindrical can 110 is open. Accordingly, during the assembling process of the secondary battery, the electrode assembly 120 may be inserted into the cylindrical can 110 together with an electrolyte. In some embodiments, the cylindrical can 110 may include (or may be formed of) steel, a steel alloy, aluminum, an aluminum alloy, etc. In some embodiments, the cylindrical can 110 may include or may be referred to as a case or housing. In some embodiments, the cylindrical can 110 may have a beading part (e.g., a bead) 113 recessed inwardly into a lower portion of the cap assembly 140 to prevent the electrode assembly 120 and the cap assembly 140 from being separated to the outside and a crimping part (e.g., a crimped end) 114 bent inwardly at the top thereof.

The electrode assembly 120 may be accommodated in the cylindrical can 110. The electrode assembly 120 includes a negative electrode plate 121 coated with a negative active material (e.g., graphite, carbon, etc.), a positive electrode plate 122 coated with a positive electrode active material (e.g., a transition metal oxide, such as LiCoO₂, LiNiO₂, LiMn₂O₄, etc.)), and a separator 123 positioned between the negative electrode plate 121 and the positive electrode plate 122 to prevent a short circuit therebetween while enabling only the movement of lithium ions. In some embodiments, the negative electrode plate 121, the positive electrode plate 122, and the separator 123 may be wound in a substantially cylindrical shape. In some embodiments, the negative electrode plate 121 may include copper (Cu) or nickel (Ni) foil, the positive electrode plate 122 may include aluminum (Al) foil, and the separator 123 may include polyethylene (PE) or polypropylene (PP). In some embodiments, a negative electrode tab 124 may be welded to the negative electrode plate 121 to protrude downwardly therefrom (e.g., to protrude downwardly therefrom by a predetermined distance), and a positive electrode tab 125 may be welded to the positive electrode plate 122 to protrude upwardly therefrom (e.g., to protrude upwardly therefrom by a predetermined length). In some embodiments, the negative electrode tab 124 may include copper or nickel, and the positive electrode tab 125 may include an aluminum material. In some embodiments, the electrode assembly 120 may be referred to as an electrode group or an electrode.

In some embodiments, the negative electrode tab 124 of the electrode assembly 120 may be welded to the bottom portion 111 of the cylindrical can 110. Therefore, the cylindrical can 110 may act as a negative electrode. In other embodiments, the positive electrode tab 125 may be welded to the bottom portion 111 of the cylindrical can 110, and in such an embodiment, the cylindrical can 110 acts as a positive electrode.

In some embodiments, a first insulation plate 126, which is coupled to the cylindrical can 110 and has a first hole (e.g., a first opening) 126a in its center and a second hole (e.g., a second opening) 126b nearer its outer edge (see, e.g., FIG. 1C), may be interposed between the electrode assembly 120 and the bottom portion 111. The first insulation plate 126 may prevent the electrode assembly 120 from electrically contacting the bottom portion 111 of the cylindrical can 110. In some embodiments, the first insulation plate 126 may prevent the positive electrode plate 122 of the electrode assembly 120 from electrically contacting the bottom portion 111. In some embodiments, the first hole 126a may allow gas to move rapidly throughout the cylindrical can 110 when a large amount of gas is generated due to an abnormality in the secondary battery, and the negative electrode tab 124 may pass through the second hole 126b to be welded to the bottom portion 111.

In some embodiments, a second insulation plate 127, which is coupled to the cylindrical can 110 and has a first hole (e.g., a first opening) 127a in its center and a plurality of second holes (e.g., second openings) 127b nearer its outer edge may be interposed between the electrode assembly 120 and the cap assembly 140. The second insulation plate 127 may prevent the electrode assembly 120 from electrically contacting the cap assembly 140. In some embodiments, the second insulation plate 127 may prevent the negative electrode plate 121 of the electrode assembly 120 from electrically contacting the cap assembly 140. In some embodiments, the first hole 127a may allow the gas to move rapidly toward the cap assembly 140 when a large amount of gas is generated due to an abnormality in the secondary battery, and the positive electrode tab 125 may pass through at least one of the second holes 127b to be welded to the cap assembly 140. The remaining second holes 127b may allow an electrolyte to quickly flow into the electrode assembly 120 during an electrolyte injection process.

The cap assembly 140 may include a cap-up 141 having a plurality of through-holes 141a, a safety vent 142 positioned under the cap-up 141, a connection ring 143 positioned under the safety vent 142, and a cap-down 144 positioned under the safety vent 142 and the connection ring 143, having a plurality of through-holes 144a, and electrically connected to the positive electrode tab 125. In some embodiments, the cap assembly 140 may further include an insulating gasket 145 that insulates the cap-up 141, the safety vent 142, and the cap-down 144 from the side portion 112 of the cylindrical can 110.

In some embodiments, the insulating gasket 145 may be compressed (e.g., substantially compressed) between the beading part 113 and the crimping part 114 formed in the side portion 112 of the cylindrical can 110. In some embodiments, the through-hole 141a in the cap-up 141 and the through-hole 144a in the cap-down 144 may discharge internal gas to the outside when an abnormal internal pressure is generated inside the cylindrical can 110. In some embodiments, the internal gas flows upwardly through the through-hole 144a in the cap-down 144 to invert the safety vent 142, thereby electrically separating the safety vent 142 from the cap-down 144 and opening (e.g., tearing or bursting) the safety vent 142 so that the internal gas may be discharged (or vented) to the outside through the through-hole 141a in the cap-up 141.

In some embodiments, an electrolyte may be injected into the inside of the cylindrical can 110, which allows lithium ions generated by an electrochemical reaction in the negative electrode plate 121 and the positive electrode plate 122 inside the battery during charging and discharging to move. The electrolyte may include a non-aqueous organic electrolyte, which is a mixture of a lithium salt and a high-purity organic solvent. In some embodiments, the electrolyte may include a polymer using a polymer electrolyte or a solid electrolyte.

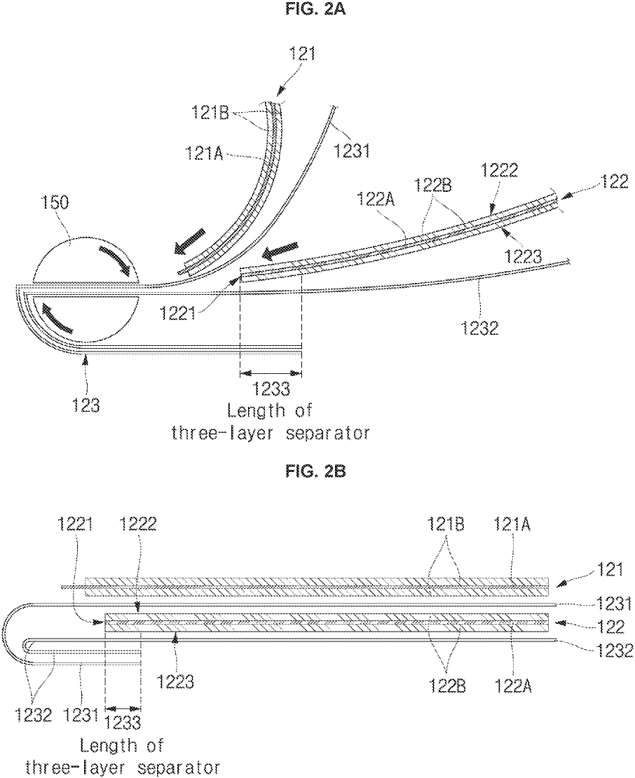

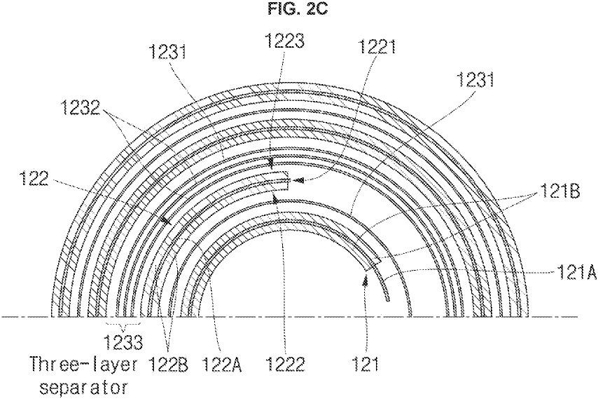

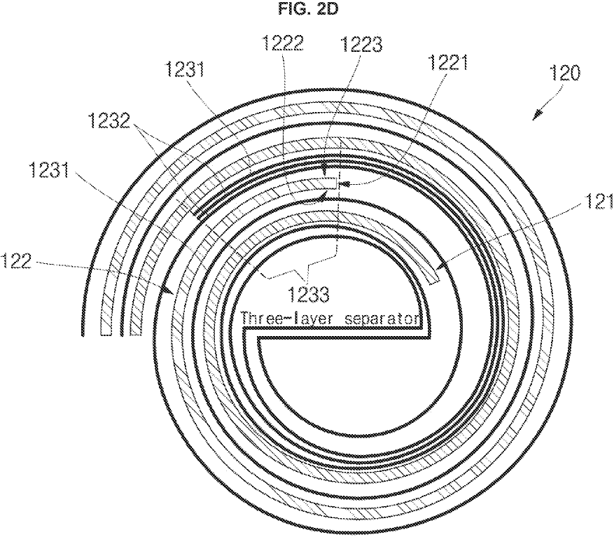

FIGS. 2A, 2B, 2C, and 2D are views showing a winding method, a winding plane, a winding center (half), and a winding center (part), respectively, of an electrode assembly 120 in a cylindrical secondary battery according to an embodiment of the present disclosure.

As described above, the electrode assembly 120 may include the negative electrode plate 121, the positive electrode plate 122, and the separator 123. In some embodiments, the negative electrode plate 121 may include a negative electrode current collector plate 121A and a negative electrode active material layer 121B coated on a surface thereof. In some embodiments, the positive electrode plate 122 may include a positive electrode current collector plate 122A and a positive electrode active material layer 122B coated on a surface thereof.

In some examples, the negative electrode plate 121 may also include a negative electrode winding leading edge (e.g., a region where winding starts), an inner surface of the negative electrode, and an outer surface of the negative electrode opposite to the inner surface of the negative electrode. In some embodiments, the positive electrode plate 122 may have a positive electrode winding leading edge 1221 (e.g., a region where winding starts or a first-wound region), a positive electrode inner surface 1222, and a positive electrode outer surface 1223 opposite to the positive electrode inner surface 1222. In some embodiments, the separator 123 may include a first separator 1231 and a second separator 1232. For example, one negative electrode plate 121 and one positive electrode plate 122 are provided but two separators 123 may be provided. In some embodiments, each of the first and second separators 1231 and 1232 may have a winding leading edge (e.g., a region where winding starts), an inner surface, and an outer surface that is opposite to the inner surface.

In some examples, during the winding process of the electrode assembly 120, ends (e.g., winding leading edges) of the first and second separators 1231 and 1232 may be first coupled to a core member 150, and then, the core member 150 may be rotated (e.g., may be rotated at least ½ rotation or at least once). Thereafter, the end (e.g., winding leading edge) of the negative electrode plate 121 may be provided to (or coupled to) the core member 150, and the end (e.g., winding leading edge) of the positive electrode plate 122 may be finally provided to the core member 150.

According to embodiments of the present disclosure, the first and second separators 1231 and 1232 may include a positive electrode protection region 1233 provided at a region corresponding to the positive electrode winding leading edge 1221 of the positive electrode plate 122, and the positive electrode protection region 1233 may prevent a deformed portion or burr that may be generated when the positive electrode plate 122 is cut from passing through the first and second separators 1231 and 1232 and shorting to the negative electrode plate 121.

As shown in FIGS. 2A and 2B, in the winding process of the electrode assembly 120, when the winding leading edges of the first and second separators 1231 and 1232 overlap the core member 150 and are through-coupled to each other, the core member 150 may be rotated clockwise. In some embodiments, the upper separator may be defined as the first separator 1231, and the lower separator may be defined as the second separator 1232.

In some embodiments, the positive electrode plate 122 may be provided between the first and second separators 1231 and 1232 to be wound. In some embodiments, the upper surface of the positive electrode plate 122 may be defined as the positive electrode inner surface 1222, and the lower surface of the positive electrode plate 122 may be defined as the positive electrode outer surface 1223. In some embodiments, the positive electrode inner surface 1222 may be a region corresponding to the negative electrode outer surface, and the positive electrode outer surface 1223 may be a region corresponding to the negative electrode inner surface.

In some embodiments, the winding leading edges of the first and second separators 1231 and 1232 and a region of the second separator 1232 provided on the outer surface of the positive electrode plate 122 may provide (or may form) a three-layer structure (e.g., a region having three layers of separator material), and the three-layer structure may be defined as the positive electrode protection region 1233. In some embodiments, the positive electrode protection region 1233 may include one layer provided by the first separator 1231 and two layers provided by the second separator 1232. In some embodiments, the second separator 1232 may overlap (or may be folded over itself) to provide the two layers thereof.

In this way, the positive electrode protection region 1233 or the region of the three-layer separator may be provided on the positive electrode outer surface 1223 of the positive electrode plate 122. For example, each of the first and second separators 1231 and 1232 may have a winding leading edge, and the winding leading edges of the first and second separators 1231 and 1232 may be provided on the positive electrode outer surface 1223 of the positive electrode plate 122.

The negative electrode plate 121 may be provided on the first separator 1231 to be wound. In some embodiments, the winding leading edge of the negative electrode plate 121 may be closer to the core member 150 than the winding leading edge of the positive electrode plate 122. Accordingly, after the winding of the electrode assembly 120 is completed, the winding leading edge of the positive electrode plate 122 may be positioned on the negative electrode plate 121 (see, e.g., FIGS. 2C and 2D).

As shown in FIGS. 2C and 2D, the winding leading edge of the positive electrode plate 122 is provided on the negative electrode plate 121 at the region where the winding of the electrode assembly 120 starts, and the positive electrode protection region 1233 of the first, second separator 1231, 1232 or the region of the three-layer separator may be provided on the positive electrode outer surface 1223 of the positive electrode plate 122. For example, the positive electrode protection region 1233 of the first, second separator 1231, 1232 may be provided in the region corresponding to the positive electrode winding leading edge 1221 of the positive electrode plate 122. In other words, the region of the one-layer separator provided by the first separator 1231 and the region of the two-layer separator provided by the second separator 1232 may form the positive electrode protection region 1233, and the positive electrode protection region 1233, which is an outer surface of the positive electrode plate 122, may be provided at the region corresponding to the winding leading edge of the positive electrode plate 122.

In some embodiments, the winding leading edges of the first and second separators 1231 and 1232 are provided on the outer surface of the positive electrode plate 122, and the winding leading edge of the positive electrode plate 122 is provided on the inner surface of the positive electrode protection region 1233. Thus, regions connecting (or extending between) the winding leading edges of the first and second separators 1231 and 1232 and the winding leading edge of the positive electrode plate 122 may be approximately arc-shaped.

Accordingly, embodiments of the present disclosure can suppress a direct short circuit between the positive electrode plate 122 and the negative electrode plate 121 in the center region (e.g., the region where winding starts) of the electrode assembly 120. For example, even if the winding leading edge of the positive electrode plate 122 has burrs in the winding center region of the electrode assembly 120 or the winding leading edge of the positive electrode plate 122 is deformed, by forming a three-layer separator portion (e.g., the positive electrode protection region 1233) to be positioned between the positive electrode outer surface 1223 of the positive electrode plate 122 and the negative electrode inner surface of the negative electrode plate 121, the positive electrode winding leading edge 1221 may not be directly shorted to the negative electrode plate 121.

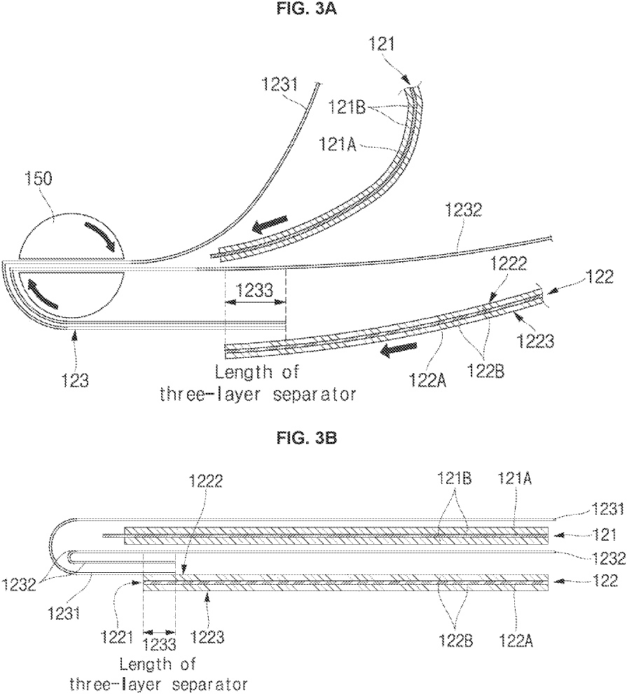

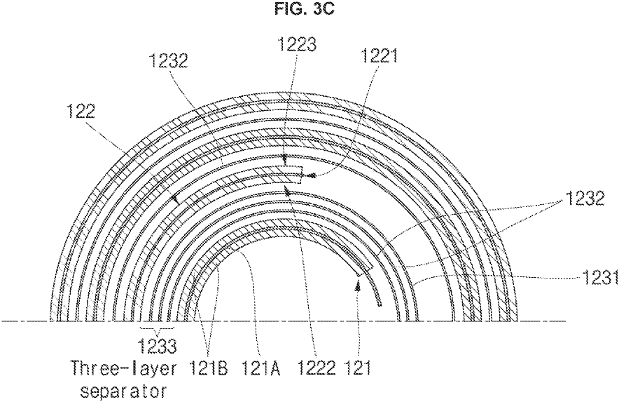

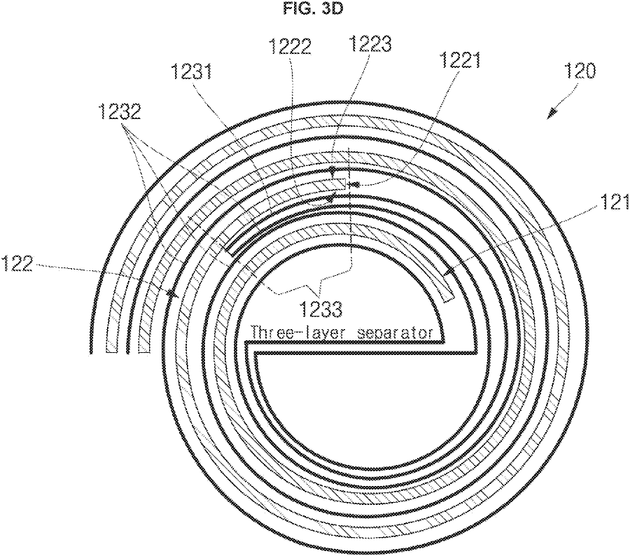

FIGS. 3A, 3B, 3C, and 3D are views showing a winding method, a winding plane, a winding center (half), and a winding center (part), respectively, of an electrode assembly 120 in a cylindrical secondary battery according to an embodiment of the present disclosure.

As shown in FIGS. 3A and 3B, in the winding process of the electrode assembly 120, when the winding leading edges of the first and second separators 1231 and 1232 overlap the core member 150 and are through-coupled to each other, the core member 150 can be rotated clockwise.

In some embodiments, the positive electrode plate 122 may be provided and wound under the winding leading edges of the first and second separators 1231 and 1232 extending through the core member 150. In some embodiments, the positive electrode plate 122 may be provided under the winding leading edge of the first separator 1231 extending through the core member 150.

In some embodiments, the winding leading edges of the first and second separators 1231 and 1232 and a region of the second separator 1232 provided on the positive electrode inner surface 1222 of the positive electrode plate 122 may form a three-layer structure (e.g., a region of three layers of separator material), and the three-layer structure may be defined as the positive electrode protection region 1233. In some embodiments, the positive electrode protection region 1233 may include a one-layer separator region provided by the first separator 1231 and a two-layer separator region provided by the second separator 1232. In some embodiments, the region of the two-layer separator may be provided with the second separator 1232 overlapping (e.g., the second separator 1232 may be folded over itself to provide the two layers of separator material).

The positive electrode protection region 1233 or the region of the three-layer separator may be provided on the positive electrode inner surface 1222 of the positive electrode plate 122. For example, each of the first and second separators 1231 and 1232 may have a winding leading edge, and the winding leading edges of the first and second separators 1231 and 1232 may be provided on the positive electrode inner surface 1222 of the positive electrode plate 122.

The negative electrode plate 121 may be provided on the first separator 1231 to be wound. In some embodiments, the winding leading edge of the negative electrode plate 121. In some examples, the negative electrode winding leading edge of the negative electrode plate 121 may be closer to the core member 150 than the positive electrode winding leading edge 1221. Accordingly, after the winding of the electrode assembly 120 is completed, the positive electrode winding leading edge 1221 of the positive electrode plate 122 may be positioned on the negative electrode plate 121 (see, e.g., FIGS. 3C and 3D).

As shown in FIGS. 3C and 3D, the positive electrode winding leading edge 1221 of the positive electrode plate 122 is provided on the negative electrode plate 121 at the region where the winding of the electrode assembly 120 starts, and the positive electrode protection region 1233 of the first, second separator 1231, 1232 or the region of the three-layer separator may be provided on the positive electrode inner surface 1222 of the positive electrode plate 122. For example, the positive electrode protection region 1233 of the first, second separator 1231, 1232 may be provided at the region corresponding to the positive electrode winding leading edge 1221 of the positive electrode plate 122. The region of the one-layer separator provided by the first separator 1231 and the region of the two-layer separator provided by the second separator 1232 may provide the positive electrode protection region 1233, and the positive electrode protection region 1233, which is a positive electrode inner surface 1222 of the positive electrode plate 122, may be provided at the region corresponding to the positive electrode winding leading edge 1221 of the positive electrode plate 122.

In some embodiments, the winding leading edges of the first and second separators 1231 and 1232 are provided on the positive electrode inner surface 1222 of the positive electrode plate 122, and the positive electrode winding leading edge 1221 of the positive electrode plate 122 is provided on the outer surface of the positive electrode protection region 1233. Thus, regions connecting (or extending between) the winding leading edges of the first and second separators 1231 and 1232 and the positive electrode winding leading edge 1221 of the positive electrode plate 122 may be approximately arc-shaped.

Embodiments of the present disclosure can suppress a direct short circuit between the positive electrode plate 122 and the negative electrode plate 121 in the winding center region (e.g., the region where winding starts) of the electrode assembly 120. For example, even if the positive electrode winding leading edge 1221 of the positive electrode plate 122 has burrs in the winding center region of the electrode assembly 120 or the winding leading edge of the positive electrode plate 122 is deformed, by forming a three-layer separator (e.g., the positive electrode protection region 1233) between the positive electrode inner surface 1222 of the positive electrode plate 122 and the negative electrode outer surface of the negative electrode plate 121, the winding leading edge of the positive electrode plate 122 may not be directly shorted to the negative electrode plate 121.

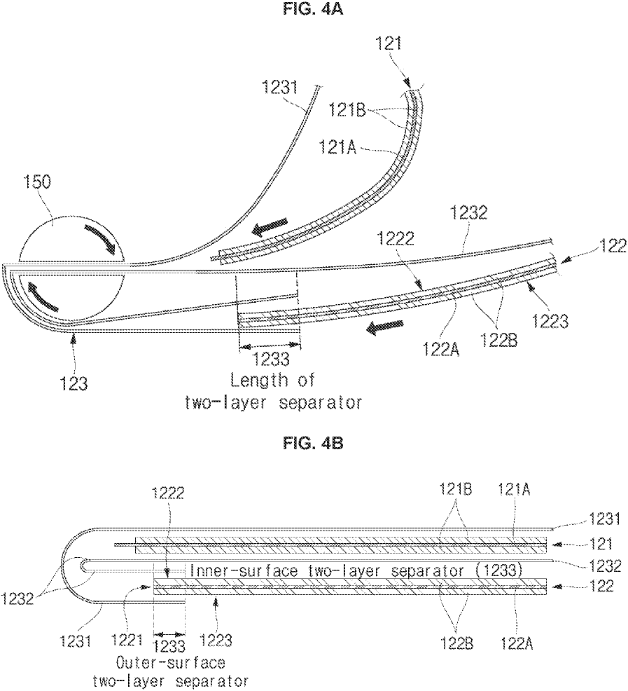

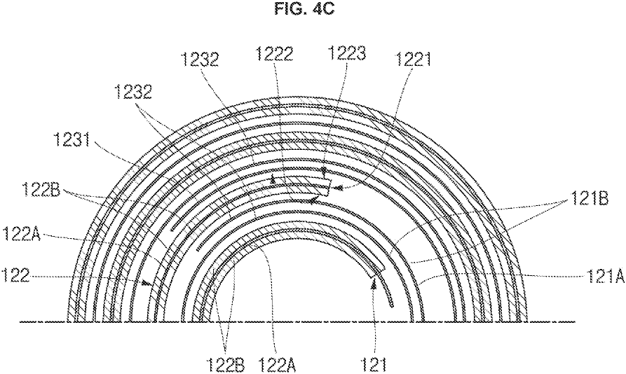

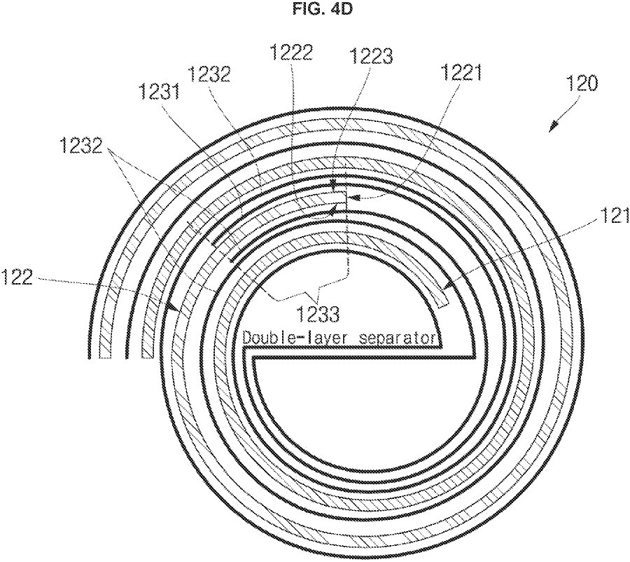

FIGS. 4A, 4B, 4C, and 4D are views showing a winding method, a winding plane, a winding center (half), and a winding center (part), respectively, of an electrode assembly 120 in a cylindrical secondary battery according to an embodiment of the present disclosure.

As shown in FIGS. 4A and 4B, in the winding process of the electrode assembly 120, when the winding leading edges of the first and second separators 1231 and 1232 overlap the core member 150 and are through-coupled to each other, the core member 150 may be rotated clockwise. In some embodiments, a positive electrode plate 122 may be coupled to the winding leading edge of the first and second separators 1231 and 1232 extending through the core member 150 to be wound. In some embodiments, the positive electrode plate 122 may be provided between winding leading edges of the first and second separators 1231 and 1232 extending through the core member 150. In some embodiments, a positive electrode winding leading edge 1221 of the positive electrode plate 122 may be coupled and wound in a region between the winding leading edges of the first and second separators 1231 and 1232.

In some embodiments, the winding leading edge of the first separator 1231 and a region of the first separator 1231 provided on the positive electrode inner surface 1222 of the positive electrode plate 122 may form a two-layer structure (e.g., a region of two layers of separator material), and the winding leading edge of the second separator 1232 and a region of the second separator 1232 provided to a positive electrode outer surface 1223 of the positive electrode plate 122 may form a two-layer structure (e.g., a region of two layers of separator material). Each of the two-layer structures may be defined as a positive electrode protection region 1233. In some embodiments, the positive electrode protection region 1233 may include a two-layer separator region provided by the first separator 1231 and a two-layer separator region provided by the second separator 1232. In some embodiments, the region of the two-layer separator positioned on the positive electrode inner surface 1222 of the positive electrode plate 122 may be provided by the second separator 1232 overlapping itself, and the region of the two-layer separator positioned on the positive electrode outer surface 1223 of the positive electrode plate 122 may be provided by the first separator 1231 overlapping itself.

The positive electrode protection region 1233 or the region of the two-layer separator may be provided on the positive electrode inner surface 1222 and the positive electrode outer surface 1223 of the positive electrode plate 122, respectively. For example, the second separator 1232 may have a winding leading edge, the winding leading edge of the second separator 1232, a region of the second separator 1232 overlapping the same may be provided on the positive electrode inner surface 1222 of the positive electrode plate 122, and the winding leading edge of the first separator 1231 and the region of the first separator 1231 overlapping the same may be provided on the positive electrode outer surface 1223 of the positive electrode plate 122.

The negative electrode plate 121 may be provided between the first separator 1231 and the second separator 1232 to be wound. In some embodiments, a negative electrode winding leading edge of the negative electrode plate 121 may be closer to a core member than the positive electrode winding leading edge 1221 of the positive electrode plate 122. Accordingly, after the winding of the electrode assembly 120 is completed, the positive electrode winding leading edge 1221 of the positive electrode plate 122 may be positioned on the negative electrode plate 121 (see, e.g., FIGS. 4C and 4D).

As shown in FIGS. 4C and 4D, in the region where the winding of the electrode assembly 120 starts, the positive electrode winding leading edge 1221 of the positive electrode plate 122 is provided on the negative electrode plate 121, and, at this time, the positive electrode protection region 1233 or the two-layer separator regions of the first and second separators 1231 and 1232 may be provided on the positive electrode inner surface 1222 and the positive electrode outer surface 1223 of the positive electrode plate 122, respectively. For example, the positive electrode protection region 1233 of the first, second separator 1231, 1232 may be provided in the region corresponding to the positive electrode winding leading edge 1221 of the positive electrode plate 122. The region of the two-layer separator provided by the first separator 1231 and the region of the two-layer separator provided by the second separator 1232 may form the positive electrode protection region 1233, and the positive electrode protection region 1233, which corresponds to the positive electrode inner surface 1222 and the positive electrode outer surface 1223 of the positive electrode plate 122, may be provided in a region corresponding to the positive electrode winding leading edge 1221 of the positive electrode plate 122.

In some embodiments, the winding leading edge of the second separator 1232 may be provided on the positive electrode inner surface 1222 of the positive electrode plate 122, the winding leading edge of the first separator 1231 may be provided on the positive electrode outer surface 1223 of the positive electrode plate 122, and the positive electrode winding leading edge 1221 of the positive electrode plate 122 may be provided between the first and second separators 1231 and 1232. Thus, regions connecting (or extending between) the winding leading edges of the first and second separators 1231 and 1232 and the positive electrode winding leading edge 1221 of the positive electrode plate 122 may be approximately arc-shaped.

Embodiments of the present disclosure can suppress a direct short circuit between the positive electrode plate 122 and the negative electrode plate 121 in the winding center region (e.g., the region where winding starts) of the electrode assembly 120. For example, even if the winding leading edge of the positive electrode plate 122 has burrs in the center region of the electrode assembly 120 or the winding leading edge of the positive electrode plate 122 is deformed, by forming a two-layer separator (e.g., the positive electrode protection region 1233) on (or between) the positive electrode inner surface 1222 and the positive electrode outer surface 1223 of the positive electrode plate 122, each including the winding leading edge of the positive electrode plate 122, the winding leading edge of the positive electrode plate 122 may not be directly shorted to the negative electrode plate 121.

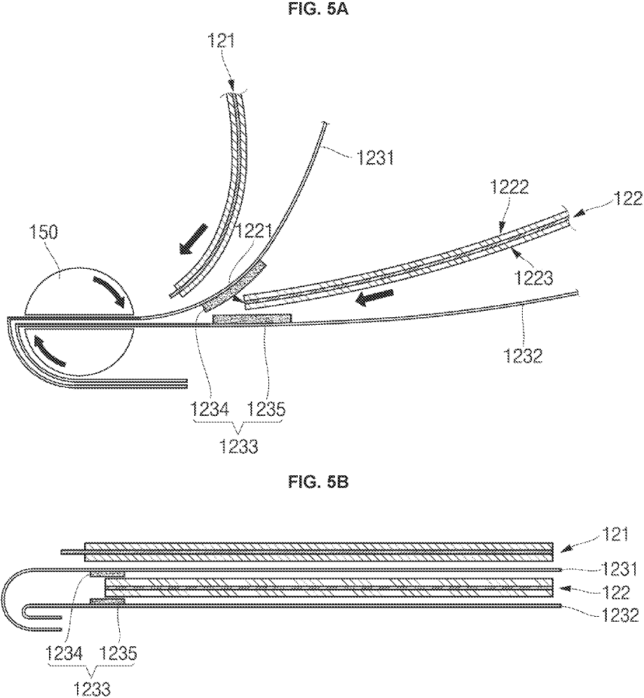

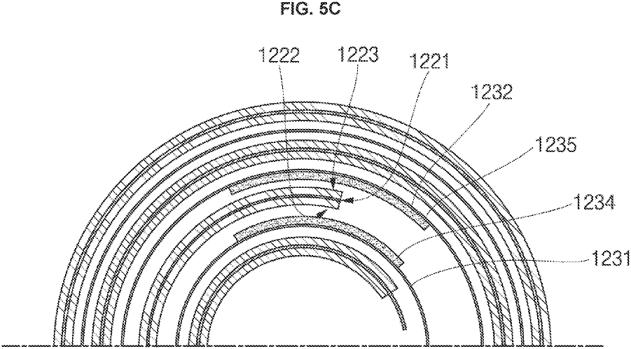

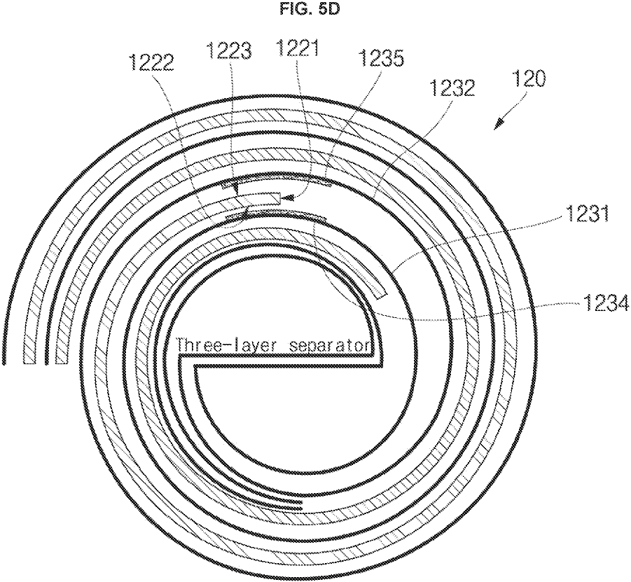

FIGS. 5A, 5B, 5C, and 5D are views showing a winding method, a winding plane, a winding center (half) and a winding center (part), respectively, of an electrode assembly 120 in a cylindrical secondary battery according to an embodiment of the present disclosure.

As shown in FIGS. 5A, 5B, 5C, and 5D, a positive electrode protection region 1233 may include a first insulating layer 1234 attached to a first separator 1231 and a second insulating layer 1235 attached to a second separator 1232. In some embodiments, the first insulating layer 1234 may be attached to portions of the first separator 1231 corresponding to a positive electrode winding leading edge 1221 and a positive electrode inner surface 1222 of a positive electrode plate 122. In some embodiments, the second insulating layer 1235 may be attached to portions of the second separator 1232 corresponding to a positive electrode winding leading edge 1221 and a positive electrode outer surface 1223 of the positive electrode plate 122. In some embodiments, the first and second insulating layers 1234 and 1235 may be made of a material that does not react with an electrolyte. In some embodiments, each of the first and second insulating layers 1234 and 1235 may be a separator itself or may be made of a polyethylene or polypropylene material that does not react with (e.g., is non-reactive with) an electrolyte.

Embodiments of the present disclosure can suppress a direct short circuit between the positive electrode plate 122 and a negative electrode plate 121 in a winding center region (e.g., a region where winding starts) of the electrode assembly 120. For example, even if the positive electrode winding leading edge 1221 of the positive electrode plate 122 has burrs in the winding center region of the electrode assembly 120 or the positive electrode winding leading edge 1221 of the positive electrode plate 122 is deformed, by providing the first and second insulating layers 1234 and 1235 on the positive electrode inner surface 1222 and the positive electrode outer surface 1223, each including the positive electrode winding leading edge 1221 of the positive electrode plate 122, the positive electrode winding leading edge 1221 of the positive electrode plate 122 may not be directly shorted to the negative electrode plate 121.

As described above, embodiments of the present disclosure provide a cylindrical secondary battery that prevents a direct short circuit between a positive electrode plate and a negative electrode plate in a winding center region (e.g., a region where winding starts) of an electrode assembly.

In one embodiment, a cylindrical secondary battery is provided in which a three-layer separator is positioned between an outer surface of a positive electrode plate and an inner surface of a negative electrode plate such that an end of the positive electrode plate is not directly shorted to the negative electrode plate even if the end of the positive electrode plate has a burr or the end of the positive electrode plate is deformed in the winding center region of the electrode assembly.

In another embodiment, a cylindrical secondary battery is provided in which a three-layer separator is positioned between an inner surface of a positive electrode plate and an outer surface of a negative electrode plate such that an end of the positive electrode plate is not directly shorted to the negative electrode plate.

In another embodiment, a cylindrical secondary battery is provided in which a two-layer separator is positioned between an inner surface of a positive electrode plate and an outer surface of a negative electrode plate such that an end of the positive electrode plate is not directly shorted to the negative electrode plate.

In another embodiment, a cylindrical secondary battery is provided in which an insulating layer is positioned between an inner surface of a positive electrode plate and an outer surface of the positive electrode plate in a winding center region of an electrode assembly such that an end of the positive electrode plate is not directly shorted to the negative electrode plate.

The foregoing embodiments are only some embodiments embodying the aspects and features of the present disclosure, and the present disclosure is not limited to these embodiments. It will be understood by a person skilled in the art that various changes in form and details may be made therein without departing from the spirit and scope of the present disclosure as defined by the following claims and their equivalents.

What is claimed is:

1. A secondary battery comprising:
a cylindrical can;
an electrode assembly in the cylindrical can, the electrode assembly comprising:
a positive electrode plate having a winding leading edge, an inner surface, and an outer surface;
a first separator covering the inner surface of the positive electrode plate;
a second separator covering the outer surface of the positive electrode plate; and
a negative electrode plate on the first separator, the first and second separators having a positive electrode protection region provided in a region corresponding to the winding leading edge of the positive electrode plate; and
a cap assembly sealing the electrode assembly by closing the cylindrical can.

2. The secondary battery of claim 1, wherein the positive electrode protection region comprises a region of at least three layers of the first and second separators.

3. The secondary battery of claim 1, wherein the positive electrode protection region comprises a one layer of separator provided by the first separator and two layers of separator provided by the second separator.

4. The secondary battery of claim 1, wherein the positive electrode protection region is on the outer surface of the positive electrode plate.

5. The secondary battery of claim 1, wherein the positive electrode protection region is on the inner surface of the positive electrode plate.

6. The secondary battery of claim 1, wherein each of the first and second separators has a winding leading edge, and
wherein the winding leading edges of the first and second separators is on the outer surface of the positive electrode plate.

7. The secondary battery of claim 1, wherein each of the first and second separators has a winding leading edge, and
wherein the winding leading edges of the first and second separators is on the inner surface of the positive electrode plate.

8. The secondary battery of claim 1, wherein the winding leading edge of the positive electrode plate is on the negative electrode plate.

9. The secondary battery of claim 1, wherein the positive electrode protection region is a region of at least two layers of separators.

10. The secondary battery of claim 1, wherein the positive electrode protection region is on the outer surface of the positive electrode plate and on the inner surface of the positive electrode plate.

11. The secondary battery of claim 1, wherein the positive electrode protection region comprises a two-layer separator region provided by the first separator and a two-layer separator region provided by the second separator.

12. The secondary battery of claim 1, wherein each of the first and second separators has a winding leading edge, the winding leading edge of the first separator being on the inner surface of the positive electrode plate, and
wherein the winding leading edge of the second separator is on the outer surface of the positive electrode plate.

13. The secondary battery of claim 1, wherein the positive electrode protection region comprises a first insulating layer attached to the first separator and a second insulating layer attached to the second separator.
